(19) United States
(12) Patent Application Publication
(10) Pub. No.: US 2026/0336651 A1
(43) Pub. Date: Oct. 29, 2026

(54) VEHICULAR LANE KEEPING SYSTEM USING SURROUND VIEW CAMERAS

(71) Applicant: Magna Electronics Inc., Auburn Hills, MI (US)

(72) Inventors: Nanubala Guru Siva Prasad, Karnataka (IN); Ramallingeswara Rao P, Andhra Pradesh (IN)

(21) Appl. No.: 19/650,582

(22) Filed: Apr. 17, 2026

Related U.S. Application Data
(60) Provisional application No. 63/794,454, filed on Apr. 25, 2025.

(51) Int. Cl. B60W 50/14; B60K 35/28; B60W 30/12; B60W 50/02; G06V 20/56

(52) U.S. Cl. CPC B60W 50/14; B60K 35/28; B60W 30/12; B60W 50/0205; G06V 20/588; B60K 2360/176; B60K 2360/178; B60K 2360/1868; B60W 2050/0215; B60W 2050/146; B60W 2420/403; B60W 2540/215; B60W 2552/15; B60W 2552/53

(57) ABSTRACT

A vehicular vision system includes a windshield-mounted camera that captures first image data. The system includes a front surround view system (SVS) camera disposed at a front of the equipped vehicle that captures second image data. An ECU, responsive to determining that the first image data captured by the windshield-mounted camera is not degraded, processes the first image data captured by the windshield-mounted camera for a vehicular driving assist system of the vehicle. The ECU, responsive to determining that the first image data captured by the windshield-mounted camera is degraded, processes the second image data captured by the front SVS camera for the vehicular driving assist system of the vehicle.

### CROSS REFERENCE TO RELATED APPLICATION

The present application claims the filing benefits of U.S. provisional application Ser. No. 63/794,454, filed Apr. 25, 2025, which is hereby incorporated herein by reference in its entirety.

### TECHNICAL FIELD

The present invention relates generally to a vehicle vision system for a vehicle and, more particularly, to a vehicle vision system that utilizes one or more cameras at a vehicle.

### BACKGROUND

Use of imaging sensors in vehicle imaging systems is common and known.

Examples of such known systems are described in U.S. Pat. Nos. 5,949,331; 5,670,935 and/or 5,550,677, which are hereby incorporated herein by reference in their entireties.

### SUMMARY

A vehicular vision system includes a windshield-mounted camera disposed at a vehicle equipped with the vehicular vision system and viewing exterior of the vehicle. The windshield-mounted camera captures first image data. The windshield-mounted camera includes a first imager. The system includes a front surround view system (SVS) camera disposed at a front of the equipped vehicle and viewing exterior of the vehicle. The front SVS camera captures second image data and includes a second imager. The system includes an electronic control unit (ECU) with electronic circuitry and associated software. The electronic circuitry of the ECU includes an image processor for processing image data captured by the windshield-mounted camera and the front SVS camera. The ECU, responsive to determining that the first image data captured by the windshield-mounted camera is not degraded, processes the first image data captured by the windshield-mounted camera for a vehicular driving assist system of the vehicle. The ECU, responsive to determining that the first image data captured by the windshield-mounted camera is degraded, processes the second image data captured by the front SVS camera for the vehicular driving assist system of the vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a plan view of a vehicle equipped with a windshield-mounted front camera;

FIG. 3 is a perspective view of the windshield-mounted front camera of FIG. 2;

FIG. 4 is a plane view of a vehicle equipped with four surround view system (SVS) cameras;

FIG. 5 is a perspective view of a display displaying a 360-degree view of a vehicle's surroundings; and

FIG. 6 is a block diagram of the vision system of FIG. 1.

### DETAILED DESCRIPTION

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

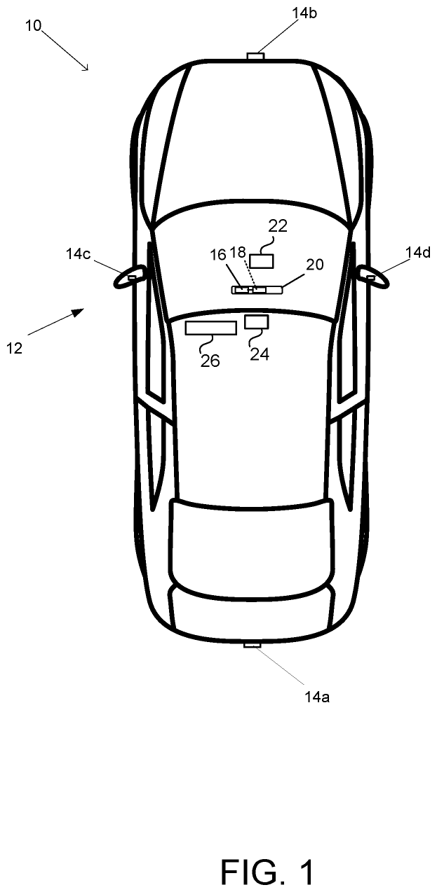

Referring now to the drawings and the illustrative embodiments depicted therein, a vehicle 10 includes an imaging system or vision system 12 that includes at least one exterior-viewing imaging sensor or camera, such as a rear backup camera or rearward-viewing imaging sensor or camera 14a (and the system may optionally include multiple exterior-viewing imaging sensors or cameras, such as a forward-viewing camera 14b at the front (or at the windshield) of the vehicle, and a sideward/rearward-viewing camera 14c, 14d at respective sides of the vehicle), which captures images exterior of the vehicle, with the camera having a lens for focusing images at or onto an imaging array or imaging plane or imager of the camera (FIG. 1). Optionally, a forward-viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

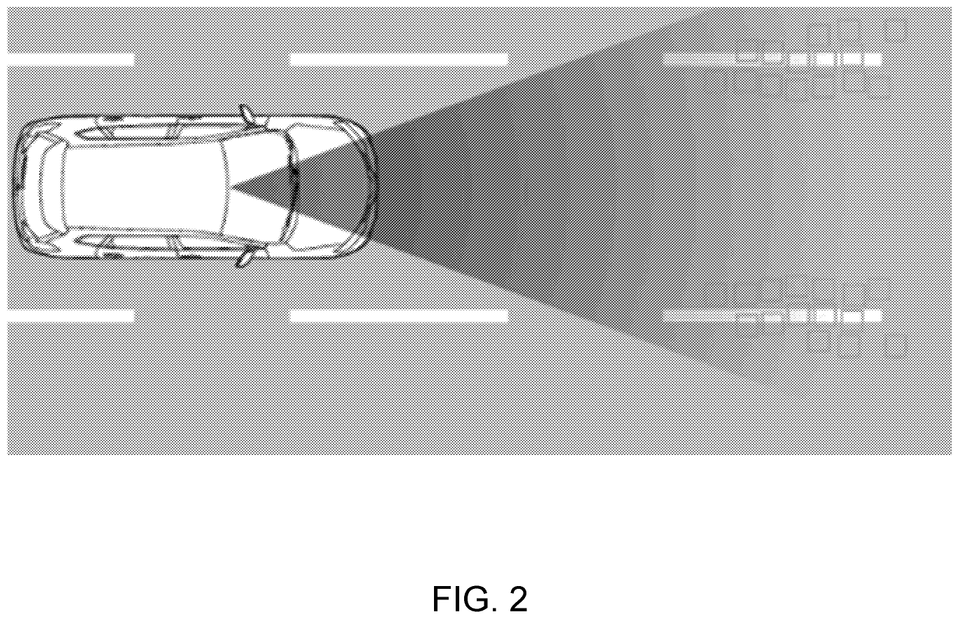

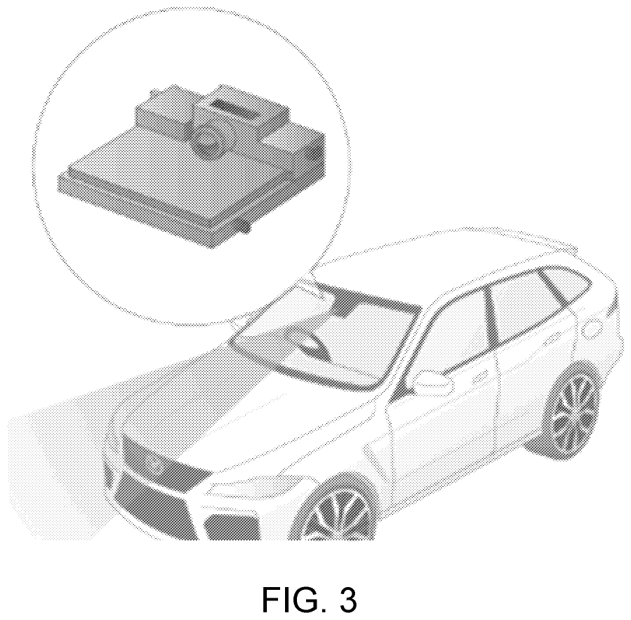

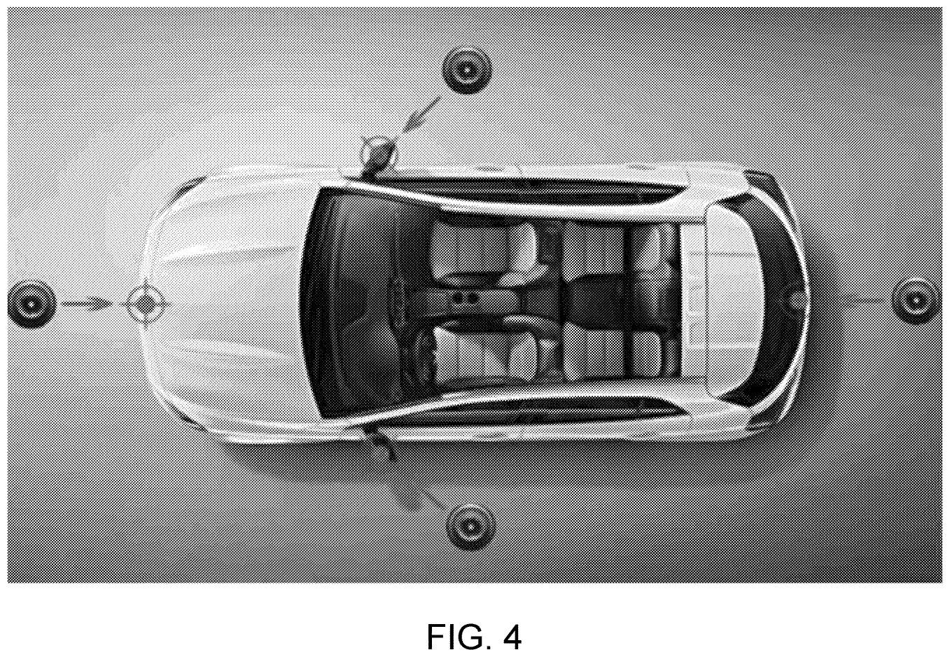

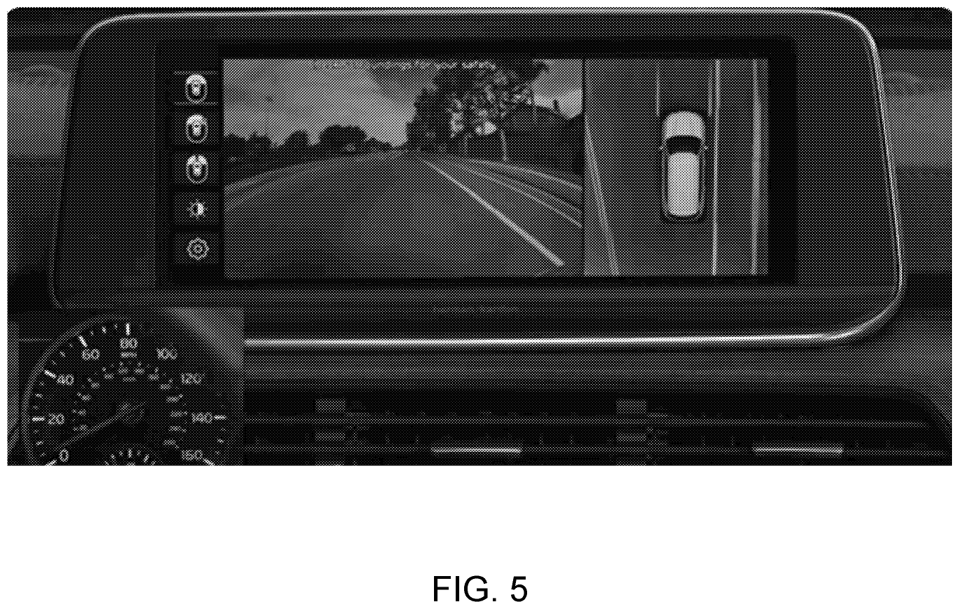

The vehicular vision system 12 and/or a vehicular driving assist system may use a windshield-mounted camera 22 (FIGS. 2 and 3) for assisting a driver with lane centering of the vehicle 10 by providing continuous steering torque and for providing warnings when the vehicle 10 deviates from a travel lane. The vehicle 10 is equipped with a surround view system (SVS) having cameras positioned at the front, rear, left, and right of the vehicle 10 (FIG. 4). For example, the SVS includes a front surround view system (SVS) camera 14b, a rear SVS camera 14a, and side SVS cameras 14c, 14d. The SVS assists the driver by providing a real-time 360-degree view of surroundings of the vehicle 10, aiding during reversing maneuvers and parking maneuvers of the vehicle 10 (FIG. 5). The SVS may display views from the side SVS cameras 14c, 14d on a human-machine interface (HMI) 24 to show blind spots. Furthermore, views from the front SVS camera 14b and the rear SVS camera 14a may be displayed on the HMI 24 based on driver input selections, optionally via controls on an instrument cluster 26. In an exemplary implementation, a view of the front SVS camera 14b may be displayed on the HMI 24 when a gear selector is in a drive mode and the driver selects to view a front perspective. In further examples, the windshield-mounted camera 22 captures first image data and the front SVS camera 14b captures second image data. An electronic control unit (ECU) 18 processes the first image data and the second image data to detect objects, lane markings, and obstacles in a path of the vehicle 10.

Situations may arise where the windshield-mounted camera 22 is degraded or not operating as expected. Such situations may include internal hardware damage, for example, damage to printed circuit board (PCB) circuit components within a camera unit of the windshield-mounted camera 22. Camera occlusion, which may occur due to environmental conditions such as sun glare, debris, dirt, snow, or ice at a windshield of the vehicle 10, may render the windshield-mounted camera 22 temporarily partially degraded, fully degraded, or non-operational. Similarly, significant misalignment of the windshield-mounted camera 22, such as due to an impact at the windshield-mounted camera 22, may be determined via image processing of the first image data captured by the windshield-mounted camera 22. Such misalignment may render the windshield-mounted camera 22 temporarily partially degraded, fully degraded, or non-operational. Additionally, the windshield-mounted camera 22 may experience difficulty detecting lane markings when the vehicle 10 is traveling on roads with a steep incline, such as incline angles greater than 30 degrees encountered on flyovers, overpasses, bridges, or specific terrains. In some examples, degradation of the windshield-mounted camera 22 comprises physical blockage of a lens of the windshield-mounted camera 22 or internal electronic faults within a complementary metal-oxide-semiconductor (CMOS) imaging array of the windshield-mounted camera 22.

A determination by the ECU 18 that the first image data captured by the windshield-mounted camera 22 is degraded may be based on continuous monitoring of operational status of the windshield-mounted camera 22 and monitoring of quality of the first image data. As used herein, the first image data being degraded encompasses scenarios where the first image data is of insufficient quality for reliable processing and scenarios where the first image data is completely absent. For example, the ECU 18 may determine that the first image data is degraded responsive to receiving no image data from the windshield-mounted camera 22 for a predetermined period of time. A complete absence of the first image data may result from a severed communication link, a power loss, or a total hardware failure at the windshield-mounted camera 22. Furthermore, the ECU 18 may process the first image data to assess various image quality metrics, such as detecting image characteristics indicative of occlusion or sun glare. Occurrences of occlusion may present as substantially uniform dark frames, substantially uniform bright frames, or a lack of expected texture or features within the first image data. Occurrences of sun glare may present as excessive saturation or elevated brightness levels in significant portions of the first image data. Additionally or alternatively, the ECU 18 may monitor performance of the vehicular driving assist system when using the first image data. In some implementations, the ECU 18 may determine that the first image data is degraded responsive to a confidence level associated with lane marker detection dropping below a predetermined operational threshold for a period of time, indicating an inability to reliably perform a lane keeping function. In further examples, the ECU 18 processes the first image data using edge detection algorithms or contrast analysis algorithms to determine whether the confidence level meets the predetermined operational threshold. Furthermore, the determination of degradation may be responsive to receiving diagnostic information, status flags, or fault codes directly from the windshield-mounted camera 22 via a data communication link, indicative of an internal hardware malfunction or another operational fault. Responsive to determining the first image data captured by the windshield-mounted camera 22 is not degraded, the ECU 18 processes the first image data for the vehicular driving assist system of the vehicle 10. Conversely, responsive to determining the first image data is degraded, the ECU 18 processes the second image data captured by the front SVS camera 14b for the vehicular driving assist system of the vehicle 10.

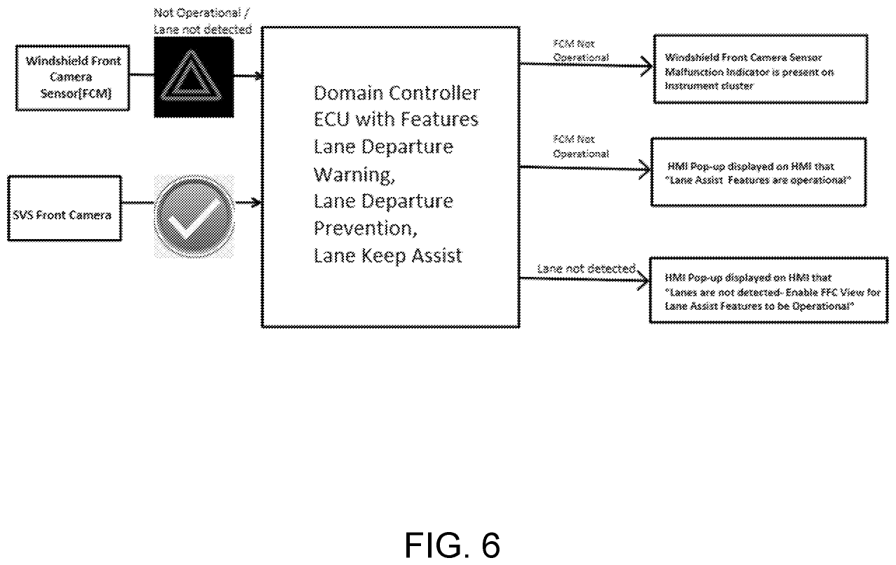

As shown in FIG. 6, to address scenarios where the windshield-mounted camera 22 is degraded, the front SVS camera 14b (which may be mounted low on a front fascia of the vehicle 10, such as at a grille or a front bumper area of the vehicle 10) may provide input for lane assist and lane control features (or other driving assist features, such as pedestrian detection, collision avoidance, adaptive cruise control, automatic emergency braking, and the like) when the windshield-mounted camera 22 is compromised. For example, when the windshield-mounted camera 22 or a lane marker detection system becomes degraded or non-operational due to a malfunction (which may be indicated by a malfunction indicator presented on the instrument cluster 26) or due to occlusion from conditions such as sun glare, the vehicular vision system 12 may switch a live image input source. In some examples, a live image feed provided to the ECU 18 may transition from the malfunctioning or occluded windshield-mounted camera 22 to the front SVS camera 14b.

In scenarios involving travel on a road with a steep angle exceeding a threshold amount (such as 30 degrees), where the windshield-mounted camera 22 fails to detect travel lanes, the vehicular vision system 12 may switch the live image input source or may display a message to a driver that prompts the driver to enable a view from the front SVS camera 14b via the HMI 24. In response to the driver enabling the view from the front SVS camera 14b, the live image feed supplied to the ECU 18 may switch to originate from the front SVS camera 14b. This utilization of the front SVS camera 14b as a redundant sensor allows the lane assist and lane control features to continue functioning. In some implementations, to facilitate a seamless transition, the ECU 18 may apply a geometric transformation to the second image data captured by the front SVS camera 14b to compensate for a lower mounting height of the front SVS camera 14b compared to the windshield-mounted camera 22. For example, the geometric transformation may apply a perspective warp or homography matrix to the second image data to approximate a viewpoint of the windshield-mounted camera 22, thereby enabling the lane marker detection system to process the second image data without modifying underlying lane detection algorithms. In some examples, the ECU 18 may crop or scale the second image data to match a resolution or field of view associated with the first image data captured by the windshield-mounted camera 22.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties. The system may determine occlusion or faulty operation of the camera via processing of image data captured by the camera. For example, the system may determine occlusion by utilizing aspects of the systems described in U.S. Pat. Nos. 9,555,736; 9,445,057; 9,319,637; 9,187,028 and/or 8,017,898, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two-dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the camera may comprise a forward-viewing camera, such as disposed at a windshield electronics module (WEM) or the like. The forward-viewing camera may utilize aspects of the systems described in U.S. Pat. Nos. 12,174,448; 11,635,672; 11,124,130; 9,896,039; 9,871,971; 9,596,387; 9,487,159; 8,256,821; 7,480,149; 6,824,281 and/or 6,690,268, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular vision system, the vehicular vision system comprising:
a windshield-mounted camera disposed at a vehicle equipped with the vehicular vision system and viewing exterior of the vehicle, the windshield-mounted camera capturing first image data;
wherein the windshield-mounted camera comprises a first imager;
a front surround view system (SVS) camera disposed at a front of the equipped vehicle and viewing exterior of the vehicle, the front SVS camera capturing second image data;
wherein the front SVS camera comprises a second imager;
an electronic control unit (ECU) comprising electronic circuitry and associated software;
wherein the electronic circuitry of the ECU comprises an image processor for processing image data captured by the windshield-mounted camera and the front SVS camera;
wherein the ECU, responsive to determining that the first image data captured by the windshield-mounted camera is not degraded, processes the first image data captured by the windshield-mounted camera for a vehicular driving assist system of the vehicle; and
wherein the ECU, responsive to determining that the first image data captured by the windshield-mounted camera is degraded, processes the second image data captured by the front SVS camera for the vehicular driving assist system of the vehicle.

2. The vehicular vision system of claim 1, wherein the vehicular driving assist system comprises at least one selected from the group consisting of (i) a lane centering system and (ii) a lane departure warning system.

3. The vehicular vision system of claim 1, wherein determining that the first image data captured by the windshield-mounted camera is degraded comprises detecting at least one selected from the group consisting of (i) an internal hardware malfunction of the windshield-mounted camera and (ii) an occlusion of the windshield-mounted camera.

4. The vehicular vision system of claim 3, wherein the occlusion of the windshield-mounted camera is caused by sun glare.

5. The vehicular vision system of claim 1, wherein determining that the first image data captured by the windshield-mounted camera is degraded is responsive to an activation of a malfunction indicator on an instrument cluster of the vehicle.

6. The vehicular vision system of claim 1, wherein determining that the first image data captured by the windshield-mounted camera is degraded comprises detecting an inability of the windshield-mounted camera to detect lane markings due to the vehicle travelling on a road having an incline angle greater than a threshold amount.

7. The vehicular vision system of claim 6, wherein responsive to detecting the inability of the windshield-mounted camera to detect lane markings due to the incline angle, a message is displayed on a human-machine interface (HMI) prompting a driver to enable a view from the front SVS camera.

8. The vehicular vision system of claim 7, wherein the ECU processes the second image data captured by the front SVS camera for the vehicular driving assist system responsive to receiving a driver input via the HMI enabling the view from the front SVS camera.

9. The vehicular vision system of claim 1, wherein determining that the first image data captured by the windshield-mounted camera is degraded comprises detecting, responsive to processing of the first image data, a misalignment of the windshield-mounted camera.

10. The vehicular vision system of claim 1, further comprising (i) a rear SVS camera disposed at a rear of the equipped vehicle, the rear SVS camera capturing third image data, and (ii) side SVS cameras disposed at respective sides of the equipped vehicle, the side SVS cameras capturing fourth image data, wherein the ECU is operable to generate a surround view display using the second image data captured by the front SVS camera, the third image data captured by the rear SVS camera, and the fourth image data captured by the side SVS cameras.

11. A method for operating a vehicular vision system, the method comprising:
capturing, by a windshield-mounted camera disposed at a vehicle and viewing exterior of the vehicle, first image data, wherein the windshield-mounted camera comprises a first imager;
capturing, by a front surround view system (SVS) camera disposed at a front of the vehicle and viewing exterior of the vehicle, second image data, wherein the front SVS camera comprises a second imager;
responsive to determining that the first image data captured by the windshield-mounted camera is not degraded, processing, by an electronic control unit (ECU) comprising an image processor, the first image data captured by the windshield-mounted camera for a vehicular driving assist system of the vehicle; and
responsive to determining that the first image data captured by the windshield-mounted camera is degraded, processing, by the ECU, the second image data captured by the front SVS camera for the vehicular driving assist system of the vehicle.

12. The method of claim 11, wherein the vehicular driving assist system comprises at least one selected from the group consisting of (i) a lane centering system and (ii) a lane departure warning system.

13. The method of claim 11, wherein determining that the first image data captured by the windshield-mounted camera is degraded comprises detecting at least one selected from the group consisting of (i) an internal hardware malfunction of the windshield-mounted camera and (ii) an occlusion of the windshield-mounted camera.

14. The method of claim 13, wherein the occlusion of the windshield-mounted camera is caused by sun glare.

15. The method of claim 11, wherein determining that the first image data captured by the windshield-mounted camera is degraded is responsive to an activation of a malfunction indicator on an instrument cluster of the vehicle.

16. The method of claim 11, wherein determining that the first image data captured by the windshield-mounted camera is degraded comprises detecting an inability of the windshield-mounted camera to detect lane markings due to the vehicle travelling on a road having an incline angle greater than a threshold amount.

17. The method of claim 16, further comprising displaying, responsive to detecting the inability of the windshield-mounted camera to detect lane markings due to the incline angle, a message on a human-machine interface (HMI) prompting a driver to enable a view from the front SVS camera.

18. The method of claim 17, wherein processing the second image data captured by the front SVS camera for the vehicular driving assist system is performed responsive to receiving a driver input via the HMI enabling the view from the front SVS camera.

19. The method of claim 11, wherein determining that the first image data captured by the windshield-mounted camera is degraded comprises detecting, responsive to processing of the first image data, a misalignment of the windshield-mounted camera.

20. The method of claim 11, further comprising:
capturing, by a rear SVS camera disposed at a rear of the vehicle, third image data;
capturing, by side SVS cameras disposed at respective sides of the vehicle, fourth image data; and
generating, by the ECU, a surround view display using the second image data captured by the front SVS camera, the third image data captured by the rear SVS camera, and the fourth image data captured by the side SVS cameras.
